(19) United States
(12) Patent Application Publication
(10) Pub. No.: US 2022/0295885 A1
(43) Pub. Date: Sep. 22, 2022

(54) Cartridge for an Electronic Cigarette

(71) Applicant: JT International S.A., Geneva (CH)

(72) Inventors: Timothy Giles Beard, Cambridge (GB); Matthew John Lawrenson, Chesterfield, MO (US)

(73) Assignee: JT International S.A., Geneva (CH)

(21) Appl. No.: 17/639,098

(22) PCT Filed: Aug. 24, 2020
(86) PCT No.: PCT/EP2020/073643

§ 371 Date: Feb. 28, 2022

(30) Foreign Application Priority Data
Aug. 30, 2019 (EP) 19194657.3

(51) Int. Cl. A24F 40/42; A24F 40/10; A24F 40/48; A24F 40/57; A24F 40/53; A24F 40/70; A24F 40/44; A24F 40/46; H05B 3/26; H05B 3/06

(52) U.S. Cl. CPC A24F 40/42; A24F 40/10; A24F 40/48; A24F 40/57; A24F 40/53; A24F 40/70; A24F 40/44; A24F 40/46; H05B 3/265; H05B 3/06; H05B 2203/005

(57) ABSTRACT

A cartridge for an electronic cigarette comprises a liquid store and a vaporizer. The vaporizer includes at least one heating element and an absorbing structure. The absorbing structure has at least one channel fluidically connected to the liquid store by a supply conduit. The at least one channel is open in a direction perpendicular to a capillary flow direction within the at least one channel, and the at least one channel is configured to conduct liquid from the liquid store to the at least one heating element.

### FIELD OF THE INVENTION

The present invention relates to an electronic cigarette as well as to a vaporizer for an electronic cigarette.

### BACKGROUND OF THE INVENTION

The term electronic cigarette, or e-cigarette, is usually applied to a handheld electronic device that simulates the feeling or experience of smoking tobacco in a traditional cigarette. Common e-cigarettes work by heating an aerosol-generating liquid to generate the aerosol that forms a vapor, which is then inhaled by the user.

Accordingly, using e-cigarettes is also sometimes referred to as “vaping”. The aerosol-generating liquid in the electronic cigarette usually comprises nicotine, propylene glycol, glycerin and flavorings. The aerosol-generating liquid is sometimes also designated as “e-liquid” or simply as “liquid”, for short.

Typical e-cigarette vaporizers, i.e. systems or sub-systems for vaporizing the liquid, utilize a cotton wick and coil system to produce vapor from liquid stored in a capsule or tank. When a user operates the e-cigarette, liquid that has soaked into the wick is heated by the coil, producing a vapor, which may then be inhaled.

However, there is a need to prevent the wick from being heated when containing an insufficient amount of liquid. Overheating a dry wick can deteriorate the taste of the vapor.

### SUMMARY OF THE INVENTION

In view of the above, it is an object of the present invention to provide a vaporizer for an electronic cigarette that reduces or eliminates the possibility of receiving a dry hit from an electronic cigarette, that is, of inhaling heated air, in which no e-liquid vapor or not enough e-liquid vapor is present. It is also an object of the present invention to provide a corresponding electronic cigarette.

The above objects are solved at least by the independent claims. Further embodiments, refinements, or upgrades are set out in the dependent claims as well as in the following description and the drawings.

It is also advantageous to achieve a predetermined and constant feed of liquid to the heater as this ensures that the temperature of the heater remains constant. If there is a lack of liquid present in the thermal proximity of the heater, the heater temperature tends to increase and there is a risk of overheating the liquid. In other cases, liquid projections may be formed if there is an excess of liquid at the heater, and when the liquid enters a boiling stage rather than a vaporization stage.

At the same time, it is desirable to ensure a high vapor volume. This is achieved by a relatively large vaporization surface and sufficient heater temperature.

The invention provides, according to a first aspect, a vaporizer for an electronic cigarette, the vaporizer being fluidically connectable to a liquid store and electrically connectable to a power supply unit in an electronic cigarette, the vaporizer comprising:

at least one heating element being connectable to the power supply unit,

an absorbing structure comprising at least one channel configured to receive liquid from the liquid store and conduct the liquid to the at least one heating element,

a pair of electrical contacts arranged about the sides of said at least one channel,

wherein the electrical contacts are connectable to an electrical control circuitry when arranged in the electronic cigarette and wherein the electrical contacts are configured to establish a closed circuit and enable a power supply to the at least one heating element only when liquid is present in the at least one channel.

In the present context, fluidically connected means that a fluid can move between the two parts of elements thus connected.

Preferably, the pair of electrical contacts is arranged at opposite sides of the at least one channel, in particular at or in walls of the at least one channel facing each other.

In some advantageous embodiments, variants, or refinements of embodiments, the electrical contacts are located in the walls of the at least one channel, and preferably located on each side of the at least one channel side by side (or facing one another) in the horizontal plane. The horizontal plane shall be understood to be perpendicular to a longitudinal direction of the electronic cigarette.

In some advantageous embodiments, variants, or refinements of embodiments, the electrical contacts are provided at the end of the at least one channel, in particular at a radially outer end with respect to a longitudinal axis of the electronic cigarette and/or at an end closer to the radial or lateral exterior of the electronic cigarette than to its interior. This is especially advantageous if the liquid is provided to the at least one channel by a central supply channel such as a liquid conduit arranged in the center of the electronic cigarette, i.e. at the other, radially inner end of the at least one channel. In this way, the electrical contacts are located at a position that has the highest likelihood of becoming dry and becoming dry first, i.e. at the most distal point from the central supply channel.

In some advantageous embodiments, variants, or refinements of embodiments, the electrical contacts are deposited in the at least one channel, preferably printed in the channel.

In some advantageous embodiments, variants, or refinements of embodiments, the at least one channel is open in a direction perpendicular to a capillary flow direction within the at least one channel. In this way, the liquid can be transported along the channel and can, once evaporated, leave the channel in said perpendicular direction, for example towards an inhaling user.

In some advantageous embodiments, variants, or refinements of embodiments, the at least one channel is a microfluidic channel. In particular, the microfluidic channels may be nanoscale microfluidic channels with width and/or depth of smaller than 1 micrometers, preferably between 10 nanometers and 850 nanometers. The absorbing structure may comprise a plurality of microfluidic channels.

In some advantageous embodiments, variants, or refinements of embodiments, the microfluidic channels of each of the at least one channel are formed by a network of channels, preferably by at least two channels running in parallel and separated by separations. The separations may have a linear shape in the longitudinal direction of the channel.

In some advantageous embodiments, variants, or refinements of embodiments, the microfluidic channels of each of the at least one channel comprise a plurality of protrusions.

Providing microfluidic channels in the at least one channel limits the effective cross-sectional flow area of the corresponding channel. This may increase the capillarity force and thus the liquid flow without the need for active pumping mechanisms or the like. The width of the channel can also be increased such that a higher liquid flow can be achieved.

In some advantageous embodiments, variants, or refinements of embodiments, the absorbing structure is a planar substrate on which the at least one channel and the at least one heating element are arranged.

In some advantageous embodiments, variants, or refinements of embodiments, the vaporizer further comprises a supply conduit configured to connect to a liquid transfer element and draw liquid by capillary action into the at least one channel.

In some advantageous embodiments, variants, or refinements of embodiments, the absorbing structure is divided into segments, and wherein each segment comprises a separate channel thermally coupled to a separate heating element. Each channel has an end connected to the supply conduit, preferably a radially inner end.

In some advantageous embodiments, variants, or refinements of embodiments, in each segment of the absorbing surface structure only a single channel is formed. In some embodiments, there may be just a single segment with just a single channel.

In some advantageous embodiments, variants, or refinements of embodiments, the at least one channel has an elongated structure, preferably a winding structure.

The invention also provides, according to a second aspect, an electronic cigarette comprising the vaporizer according to any embodiment of the first aspect. The electronic cigarette may further comprise a power supply unit and control circuitry, wherein the at least one heating element is controllable by the control circuitry such that power is supplied from the power supply unit to the at least one heating element only when there is liquid present in the at least one channel to which the at least one heating element is thermally coupled.

In some advantageous embodiments, variants, or refinements of embodiments, the control circuitry further comprises at least one switch, wherein each switch is configured to sense a liquid present in a corresponding channel and to selectively activate a heating element thermally coupled to that corresponding channel.

In some advantageous embodiments, variants, or refinements of embodiments, each switch is configured to sense a change in capacitance or resistance due to the amount of liquid present in the corresponding channel in order to determine the liquid present in the corresponding channel.

In some advantageous embodiments, variants, or refinements of embodiments, the vaporizer comprises a plurality of channels and a plurality of heating elements. Each of the heating elements may be individually controllable by the control circuitry.

According to a third aspect, the invention provides a vaporizer for an electronic cigarette, comprising an absorbing structure and a plurality of heating elements, the heating elements being connectable to a power supply unit in the electronic cigarette, wherein the absorbing structure is divided into segments, and wherein each segment is thermally coupled to a separate heating element. In this way, a more redundant design is provided and vapor can be generated more homogenously.

In some advantageous embodiments, variants, or refinements of embodiments, the absorbing structure comprises at least one channel configured to conduct liquid to the at least one heating element.

In some advantageous embodiments, variants, or refinements of embodiments, each segment comprises a separate channel.

In some advantageous embodiments, variants, or refinements of embodiments, the channels are open in a direction perpendicular to a capillary flow direction within the at least one channel. In this way, the liquid can be transported along the channel and can, once evaporated, leave the channel in said perpendicular direction, for example towards an inhaling user.

In some advantageous embodiments, variants, or refinements of embodiments, at least one of the at least one channel has a winding structure. In this way, the channel has a larger volume with respect to its depth, and covers more of the surface it is arranged in.

In some advantageous embodiments, variants, or refinements of embodiments, the power is supplied from the power supply unit to any of the plurality of heating elements only when liquid is present in a corresponding one of the at least one channel such that each segment (or, more precisely: the heating element for each segment) is individually activated upon the condition that liquid is present in said segment.

In some advantageous embodiments, variants, or refinements of embodiments, the vaporizer further comprises a pair of electrical contacts arranged about the sides of at least one channel and configured as an open loop of an electrical control circuit, and wherein the electrical control circuit is closed when liquid is present in the channel, such that the power supply to the corresponding heating element is only enabled when liquid is present in a corresponding at least one channel.

In some advantageous embodiments, variants, or refinements of embodiments, the electrical contacts are provided at the end of the at least one channel, in particular a radially outer end. In this way, the contacts are located at a position that has the highest likelihood of becoming dry and becoming dry first, i.e. at the most distal point from the central supply channel.

In some advantageous embodiments, variants, or refinements of embodiments, the vaporizer further comprises a supply conduit configured to draw liquid from the liquid store (and conduct said liquid into at least one channel.

In some advantageous embodiments, variants, or refinements of embodiments, the supply conduit is connectable to a liquid transfer element.

In some advantageous embodiments, variants, or refinements of embodiments, microfluidic channels of each of the at least one channel are formed by a network of channels. Separations may be formed between the channels that have a linear shape in the longitudinal direction of the channel. Providing microfluidic channels in the at least one channel limits the effective cross-sectional flow area of the corresponding channel. This may increase the capillarity force and thus the liquid flow without the need for active pumping mechanisms or the like. The width of the channel can also be increased such that a higher liquid flow can be achieved.

In some advantageous embodiments, variants, or refinements of embodiments, the absorbing structure has a first layer in which the channels are arranged and a second layer (or: plane) which comprises at least one heating element of the plurality of heating elements, and which preferably comprises all of the plurality of heating elements.

According to a fourth aspect, the invention provides an electronic cigarette comprising a vaporizer according to any embodiment of the vaporizer according to the third aspect of the invention. The electronic cigarette may further comprise a power supply unit and control circuitry, wherein the at least one heating element of the vaporizer is controllable by the control circuitry, and wherein the control circuitry is configured such that power is supplied from the power supply unit to the at least one heating element only when there is liquid present in at least one channel to which the at least one heating element is thermally coupled.

In some advantageous embodiments, variants, or refinements of embodiments, the absorbing structure of the vaporizer comprises a plurality of segments, each connected to a separate heating element. Each of the heating elements may be individually controllable by the control circuitry. Thus, a more precise and more adaptable control of the plurality of heating elements is provided.

According to a fifth aspect, the invention provides a cartridge for an electronic cigarette, the cartridge comprising a liquid store and a vaporizer, the vaporizer comprising at least one heating element and an absorbing structure having at least one channel fluidically connected to the liquid store by a supply conduit, at least one channel being open in a direction perpendicular to a capillary flow direction within the at least one channel, and wherein the at least one channel is configured to conduct liquid from the liquid store to the at least one heating element.

In some advantageous embodiments, variants, or refinements of embodiments, the absorbing structure is divided into segments. Each segment may comprise a separate channel and each segment may be thermally coupled to a separate heating element. Thus, a more precise and more adaptable control of the plurality of heating elements is provided.

In some advantageous embodiments, variants, or refinements of embodiments, the vaporizer is formed on a substrate, and the at least one channel is formed on a first side thereof. The at least one heating element may be formed on the second surface thereof. The substrate with the channels may be formed in a sintering mold. In further advantageous variants, the substrate comprises a porous ceramic material.

In some advantageous embodiments, variants, or refinements of embodiments, the at least one heating element is arranged on the same side as the at least one channel, and is preferably arranged at a bottom portion of the channel.

In some advantageous embodiments, variants, or refinements of embodiments, the vaporizer has a planar shape. Thus, the vaporizer may have a small footprint and may be insertable into a variety of electronic cigarettes.

In some advantageous embodiments, variants, or refinements of embodiments, the at least one heating element is shaped as a track and is aligned with the at least one channel. In other words, the at least one heating element and the corresponding at least one channel may be superposed. In this way, the heating element is adapted to optimally transfer heat to the liquid arranged within the corresponding at least one channel.

In some advantageous embodiments, variants, or refinements of embodiments, the bottom of the at least one channel is coated, preferably by an impervious coating such as a vitreous glazing. The coating improves or ensures the impermeability of the channels such that liquid is not soaked up into e.g. a ceramic substrate in which the at least one channel is formed. In this way, a reduction in the capillary force may be prevented.

In some advantageous embodiments, variants, or refinements of embodiments, the supply conduit is configured to draw and transfer liquid by capillary action into the at least one channel.

In some advantageous embodiments, variants, or refinements of embodiments, the supply conduit is elongated and has a first end in connection with the vaporizer and a second end in the liquid store.

In some advantageous embodiments, variants, or refinements of embodiments, the vaporizer further comprises a pair of electrical contacts arranged about the sides of said at least one channel, wherein the electrical contacts form part of an electrical control circuit when the cartridge is arranged in an electronic cigarette, and wherein the electrical contacts are configured to establish a closed circuit and enable a power supply to the at least one heating element only when liquid is present in the at least one channel. The electrical contacts may be configured as (part of) an open loop of an electrical control circuit, to be closed by the presence of the liquid. The open circuit to be closed by the presence of the liquid may also be designated as a “sensing circuit”.

In some advantageous embodiments, variants, or refinements of embodiments, the cartridge further comprises a first electrical power circuit connected to the electrical contacts and a second electrical power circuit connected to the at least one heating element. At least one negative terminal of the first electrical power circuit may be arranged on an outer circumference of the cartridge. The electrical contacts and the power circuit to the at least one heating element may have a common negative terminal. This reduces the number of terminal contacts arranged on the cartridge. For example, the heating elements may all be connected to a ring-shaped electrical terminal. The positive terminals (electrical contact points) may be separate for each channel, while the negative terminal for the sensing circuits and the power circuit to the heating element can be common.

In some advantageous embodiments, variants, or refinements of embodiments, a terminal end (preferably the positive terminal end) of a sensing circuit is arranged on a side of the substrate, and arranged to be connected to the cartridge seating on an electronic cigarette.

In some advantageous embodiments, variants, or refinements of embodiments, the at least one channel is configured to transfer the liquid by capillary action along its entire length.

In some advantageous embodiments, variants, or refinements of embodiments, the absorbing surface may comprise a plurality of microfluidic channels.

According to a sixth aspect, the invention provides an electronic cigarette comprising a cartridge seating, a power supply unit and a control circuitry.

The cartridge seating may comprise a first pair of electrical terminals configured to power at least one heating element and a second pair of electrical terminals configured to establish at least one control circuit. The control circuitry comprises a controller configured to detect an electrical parameter (such as capacitance or resistance) of the at least one control circuit and control the supply of power to the at least one heating element such that power is supplied to the at least one heating element only when the detected electrical parameter is within a predefined parameter range. For example, detecting an electrical parameter may comprise measuring a value of the electrical parameter or otherwise determining whether the electrical parameter is in a predefined range. In some variants, if an electrical current flows through the at least one control circuit, this can be considered a detecting that the resistance of the at least one control circuit is in a predefined value range, i.e. a range that allows the conduction of electrical current.

According to a seventh aspect, the invention provides a method of manufacturing the vaporizer according to any embodiment of the first or the third aspect or of manufacturing the cartridge according to an embodiment of the fifth aspect, the method comprising the steps of:
providing a planar substrate with recesses formed as channels,
positioning electrical contact plates at a predetermined position in relation to the channels,
depositing a resistive heating element onto the planar substrate.

In some advantageous embodiments, variants, or refinements of embodiments, the at least one heating element is deposited in the recesses, preferably by printing (additive manufacturing).

Furthermore, the invention provides, according to an eighth aspect, a vaporizer for an electronic cigarette, the vaporizer comprising a liquid transfer element, an absorbing structure and at least one heating element, wherein the liquid transfer element is configured for being fluidically connected to a liquid store and for transferring liquid from the liquid store to the absorbing structure,

and wherein the absorbing structure comprises at least one channel configured to conduct liquid to, through, or over, the at least one heating element.

A liquid transfer element may be a passive element, for example, a wick such as a cotton wick, but may also be realized as an active element such as comprising, or consisting of, a pump such as a micropump. The liquid store may be permanently connected to the liquid transfer element or may be part of a replaceable consumable such as a capsule, a cartridge and/or the like.

The absorbing structure may preferably be formed as an absorbing surface structure. The term “absorbing surface structure” may in particular designate a structure which is open to the surroundings or to a cavity and which is configured to absorb liquid which has been transported to the absorbing surface structure. The absorbing may in particular be performed by capillary action or by other physical and/or chemical processes. The absorbing surface structure may be located at the end of a body member of the electronic cigarette. In particular, the absorbing surface structure may be open to a vapor chamber or cavity in which vaporized e-liquid is temporarily stored before being inhaled by the user.

The at least one heating element may be a single heating element or, preferably, a plurality of heating elements such as two or more heating elements, three or more heating elements, four or more heating elements or the like.

In some advantageous embodiments or refinements of embodiments, the at least one channel is configured to draw liquid from the liquid transfer element by capillary action. It shall be understood that, in embodiments or variants where liquid store is not permanently fluidly connected to the liquid transfer element, this is only the case when the liquid store is fluidly connected to the liquid transfer element. Drawing the liquid (or: e-liquid or aerosol-generating liquid) by capillary action is a simple, reliable, cheap and yet efficient way to draw the liquid from the liquid transfer element and thus, by proxy, from the liquid store when it is fluidly connected to the liquid transfer element.

In some advantageous embodiments or refinements of embodiments, the at least one channel comprises a plurality of micro fluidic channels.

The micro fluidic channel may be created by providing columns or pegs within the at least one channel, so that between the columns and/or pegs and the walls of the at least one channel the micro fluidic channels are defined. Such micro fluid channels are especially suitable to generate the capillary action for drawing the liquid from the liquid transfer element without any additional mechanical moving element, such as a micro pump, being present. The inventors have found that the application or principles from the field of micro fluidics within the vaporizer according to the above described aspects provides many surprising advantages.

Micro fluidics describes the manipulation of fluids at the sub-millimeter length scale and typically involves the design of microscale channels to carry fluids. At this scale, the phenomena affecting the behavior of fluids are significantly different to those at larger scales such as they are usually used in currently known electronic cigarettes. In particular, capillary forces are more dominant at the sub-millimeter scale, allowing fluids to move an opposition to gravity without an additional driving force such as the one exerted by a micro pump or the like.

Accordingly, it is preferred that a width and/or a depth of at least one of the plurality of micro fluidic channels for each of the at least one channel, preferably of all of the micro fluidic channels of the at least one channel, is smaller than 1 millimeter, for example smaller than 0.5 millimeters.

In particular, the microfluidic channels may be nanoscale microfluidic channels with width and/or depth of smaller than 1 micrometers, preferably between 10 nanometers and 850 nanometers.

Capillary action, which is also known as wicking, facilitates easy movement of fluids in a microscale system. The inventors have found that the properties of such microscale systems can be used to great advantage within electronic cigarettes as described herein. In particular, the direction of the wicking action and the micro fluid system may be controlled via tailored design of the absorbing structure generating the capillary action, here in particular the micro fluidic channels. For example, structural symmetry of the walls of the micro fluidic channels may be used to induce a direction-dependent Laplace pressure (surface tension) in the fluid to control its movement.

The micro fluidic channels may be manufactured using techniques such as the projection of light through a customized mask onto a chemically treated surface with the resulting pattern than replicated in a rubber substrate. The absorbing structure, or at least the micro fluidic channels, may also be produced on a body member by additive manufacturing (3D printing). The micro fluidic channels may also advantageously be manufactured from graphene. Thus, herein also a method for producing a vaporizer for an electronic cigarette according to embodiments of the eighth aspect of the present invention is provided.

In common electronic cigarettes, availability of liquid for heating within proximity of a heating element (such as a heating resistor) may be affected by such factors as device orientation and liquid level. Constant monitoring of these factors is possible but may be inconvenient for the user of the electronic cigarette. Moreover, it is desired by users to be as free as possible in the use of the electronic cigarettes. The use of the micro fluidic channels offers a method of manipulating the supply of liquid to the at least one heating element even when the vaporizer is in an orientation in which gravity would usually force the liquid away from the at least one heating element. As mentioned before, capillary action can overcome gravity and thus ensure that sufficient amounts of liquid are reaching and wetting at least one heating element of the at least one heating element.

Preferably, the absorbing structure is configured such that, when the liquid is absorbed by the absorbing structure, it is spread out essentially two-dimensionally over the absorbing structure, for example such that at least 50% of the absorbing structure are wetted by the e-liquid being absorbed, preferably more than 60%, more preferably more than 70%, even more preferably more than 80%. To achieve this, each channel may be structured in a winding manner, or, in other words, each channel may be formed with a winding structure. Each channel may be shaped in such a way as to maximize the area it is covering and enclosing.

By using micro fluidic channels, this effect may be realized without increasing the complexity or size of the vaporizer as compared to other solutions. The at least one channel, which may also be designated as a “heating channel”, may preferably be shaped such as to cover an according large percentage of the absorbing structure.

In some advantageous embodiments or refinements of embodiments, the micro fluidic channels in each of the at least one channel are formed by a network of channels or by a plurality of protrusions (such as columns or pegs), which limit the effective cross-sectional flow area of the corresponding channel. As has been described in the foregoing, micro fluidic channels can be formed in this way. Moreover, the plurality of protrusions may serve also in other functions, for example as electrical contacts.

In some advantageous embodiments, variants, or refinements of embodiments, the absorbing structure has a first layer in which the at least one channel is arranged and a second layer which comprises at least one heating element. The at least one heating element may be embedded in the second layer.

In some advantageous embodiments, variants, or refinements of embodiments, the absorbing structure is divided into segments, for example two or more segments, three or more segments, four or more segments, five or more segments, six or more segments, seven or more segments, eight or more segments, or the like. The number of segments may be determined by factors including the required granularity of the heating control capabilities (as defined by e.g. a manufacturer), and any design constraints associated with the manufacture of microfluidic channels.

More segments result in a more homogeneous distribution of the generated vapor even if some of the heating elements are in a particular moment not heating in order to avoid dry burning. Preferably, the segments are all of the same size and/or arranged in a rotational symmetry in order to provide an even more homogeneous distribution of the generated vapor.

Preferably, the segments are formed as circle sectors (i.e. as portions of a disk enclosed by two radii and an arc), more preferably as equally-sized circle sectors and/or arranged in such a way that all of the segments together form essentially a disk, wherein however the individual segments are preferably thermally isolated from one another, e.g. by an insulating material or by a gap.

Optionally, each segment comprises a separate channel thermally coupled (e.g. physically connected) to a separate heating element, and each of these channels has an end connected to the liquid transfer element. Preferably, each segment is provided with at least one heating element. In this way, each segment acts as an independent vaporizing unit which is preferably designed such that the corresponding heating elements of each segment only generate heat when there is e-liquid present at, or in the proximity of, the corresponding heating elements. This further reduces the chances of dry hits since no dry hit occurs if at least one of the segments is supplied with e-liquid at all times.

Preferably, the absorbing structure comprises a plurality of segments with each segment connected to a separate heating element, and wherein each of the heating elements is individually controllable by control circuitry. The control circuitry may be comprised in the vaporizer, or the vaporizer may comprise electrical contacts for connecting to an external control circuitry (for example, in the main body of an electronic cigarette) such that the control circuitry may control each of the heating elements individually.

Advantageously, the individual segments are thermally isolated from one another. This contributes to each segment being individually controllable, in particular heatable, to individually controllably generate vapor.

In some advantageous embodiments, variants, or refinements of embodiments, the absorbing structure is electrically conductive.

In some advantageous embodiments, variants, or refinements of embodiments, the absorbing structure comprises a metal, such as Titanium.

In some advantageous embodiments, variants, or refinements of embodiments, the absorbing structure comprises a ceramic material.

In some advantageous embodiments, variants, or refinements of embodiments, the segments are manufactured from graphene and/or oxide-coated copper. These materials have favorable thermal conductivity values so that the segments transmit the heat produced by the heating elements well.

In some advantageous embodiments, variants, or refinements of embodiments, in each segment of the absorbing structure only a single channel is formed. The single channel may be formed with a winding structure and/or such as to maximize the percentage of the area of the corresponding segment that is covered by the channel.

Alternatively, the channels may be formed between the individual segments and such as to separate the segments from one another.

In some advantageous embodiments, variants, or refinements of embodiments, the at least one channel is open in a direction perpendicular to the capillary flow direction within the at least one channel. In this way, the liquid can be transported along the channel and can, once evaporated, leave the channel in said perpendicular direction, for example towards an inhaling user.

In some advantageous embodiments, variants, or refinements of embodiments, the at least one channel has a winding structure, i.e. in such a way that the liquid changes direction multiple times along each respective channel and such that multiple sections of the channel are arranged essentially (or completely) in parallel to one another, and preferably such that the majority of the channel is comprised of sections that are arranged essentially (or completely) in parallel to one another. In this way, a channel of comparatively large length can be provided in a comparatively small area.

The invention also provides, according to a ninth aspect, an electronic cigarette comprising the vaporizer according to any embodiment of the eighth aspect of the present invention. The electronic cigarette may further comprise a power supply unit and control circuitry, wherein the at least one heating element of the vaporizer is controllable by the control circuitry.

The control circuitry is configured such that power is supplied from the power supply unit to the at least one heating element only when there is liquid present in the at least one channel to which the at least one heating element is thermally connected. In some variants, the control circuitry may be provided partially within the vaporizer.

The term “thermally connected” in this context may be understood to mean that the heating element is configured to apply heat to the corresponding channel such that the heating element is able to vaporize e-liquid contained in at least one section of the channel.

The electronic cigarette may, apart from the vaporizer, also comprise a liquid store for storing the liquid for transport, by the liquid transfer element, to the absorbing structure, and may also comprise a housing, a battery portion, a user interface and/or further functional portions or circuits. The liquid store may also be part of the vaporizer.

In some advantageous embodiments, variants, or refinements of embodiments, the absorbing structure of the vaporizer comprises a plurality of segments, each connected to a separate heating element, and each of the heating elements is individually controllable by the control circuitry.

In some advantageous embodiments, variants, or refinements of embodiments, the control circuitry of the electronic cigarette further comprises at least one switch, and preferably each switch is configured to sense a liquid present in a corresponding one of the channels and to selectively activate a heating element thermally coupled (or: connected) to that corresponding channel.

In some advantageous embodiments, variants, or refinements of embodiments, each switch is configured to sense a change in capacitance due to the amount of liquid present in the corresponding channel in order to sense the liquid present in the corresponding channel. In these cases, it is advantageous if the electronic cigarette is used with electrically non-conductive liquid.

In some advantageous embodiments, variants, or refinements of embodiments, each switch comprises (or is connected to) a first electrical contact and a second electrical contact, and each switch is configured to be closed by the presence of an electrically conductive liquid within the corresponding channel in order to sense the liquid present in the corresponding channel.

In some advantageous embodiments, variants, or refinements of embodiments, each switch is located at the far end, with respect to the transfer element, of the corresponding channel. This is especially advantageous if the switch is configured to be directly triggered by the presence of a sufficient amount of liquid at the switch itself.

In some advantageous embodiments, variants, or refinements of embodiments, at least some, and preferably all, of the electrical contacts for each channel have a linear shape and extend over a plurality of windings of the corresponding channel.

According to a tenth aspect, the invention further provides a use of a vaporizer according to any embodiment of the first aspect, the third aspect, or the seventh aspect of the present invention or a use of a cartridge according to any embodiment of the fifth aspect of the present invention, or of an electronic cigarette according to any embodiment of the second, fourth, sixth or ninth aspect of the present invention, with an electrically non-conductive e-liquid. In this case, the e-liquid can be used to non-conductively change the capacitance between to electrical contacts for controlling at least one heating element.

According to an eleventh aspect, the invention further provides a use of a vaporizer according to any embodiment of the first aspect, the third aspect, or the seventh aspect of the present invention or a use of a cartridge according to any embodiment of the fifth aspect of the present invention, or of an electronic cigarette according to any embodiment of the second, fourth, sixth or ninth aspect of the present invention, with an electrically conductive e-liquid. In this case, the e-liquid can be used to close an electrical circuit between to electrical contacts for closing a switch for controlling at least one heating element.

According to a twelfth aspect, the invention further provides a vaporizer for an electronic cigarette, the vaporizer comprising a liquid transfer element configured for being fluidically connected to a liquid store and for transferring liquid out of the liquid store when connected to the liquid store, an absorbing structure comprising at least one channel, the absorbing structure fluidically connected to the liquid transfer element and configured to conduct liquid transferred by the transfer element via the at least one channel towards, to, and/or through at least one heating element thermally coupled (or: connected) to the channel, a power supply unit, and control circuitry configured such that power is supplied from the power supply unit to each heating element only when there is liquid present in the channel to which the heating element is thermally coupled (or: connected).

Although many features have been described herein with respect to a particular aspect of the invention, it will be understood that the features may, if not explicitly contradictive, be in the same way or similarly included in embodiments of different aspects of the invention. Any embodiment of the invention may be an embodiment of not only one but also of a plurality or even of all aspects of the present invention.

### BRIEF DESCRIPTION OF THE DRAWINGS

The invention will be explained in greater detail with reference to exemplary embodiments depicted in the drawings as appended.

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 schematically illustrates an electronic cigarette according to an embodiment of the present invention;

FIG. 2 schematically illustrates a vaporizer according to an embodiment of the present invention;

FIG. 3 control circuitry of an electronic cigarette according to an embodiment of the present invention or of, or for use with, a vaporizer according to an embodiment of the present invention; and

FIG. 4 schematically illustrates a vaporizer according to another embodiment of the present invention;

FIG. 5 schematically illustrates a vaporizer according to yet another embodiment of the present invention;

FIG. 6 schematically illustrates a vaporizer according to still another embodiment of the present invention;

FIG. 7 schematically illustrates a vaporizer according to yet another embodiment of the present invention;

FIG. 8 schematically illustrates a cartridge according to yet another embodiment of the present invention; and

FIG. 9 schematically illustrates an electronic cigarette in combination with the cartridge according to FIG. 8.

### DETAILED DESCRIPTION OF THE INVENTION

Although specific embodiments have been illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

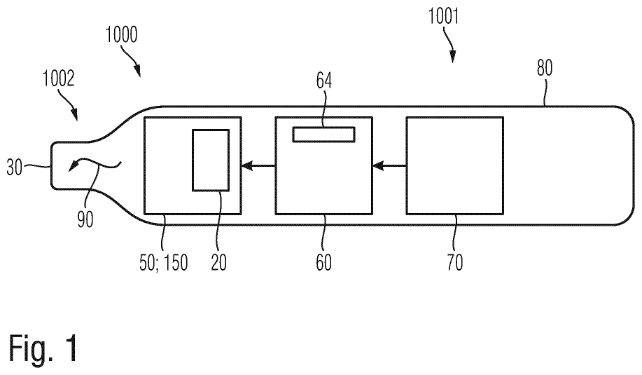

FIG. 1 schematically illustrates an electronic cigarette 1000 according to an embodiment of the present invention. The electronic cigarette 1000 comprises a main body portion 1001 and a mouthpiece portion 1002. The main body portion 1001 comprises a power supply unit 70 and control circuitry 60 configured for controlling the supply of electrical power from the power supply unit 70. The electronic cigarette 1000 further comprises a vaporizer 50, a liquid store 20 and a mouthpiece 30, through which a user can inhale the generated vapor 90.

In an embodiment, the main body portion 1001 and the mouthpiece portion 1002 may be removably connected to each other to provide access to a refillable liquid store 20 in the mouthpiece portion 1002. In such a case, the main body portion 1001 of the electronic cigarette 1000 may comprise a vaporizer seating for a removable vaporizer.

In another embodiment, the main body portion 1001 can be provided with a cartridge seating configured to receive a liquid cartridge with an integrated vaporizer.

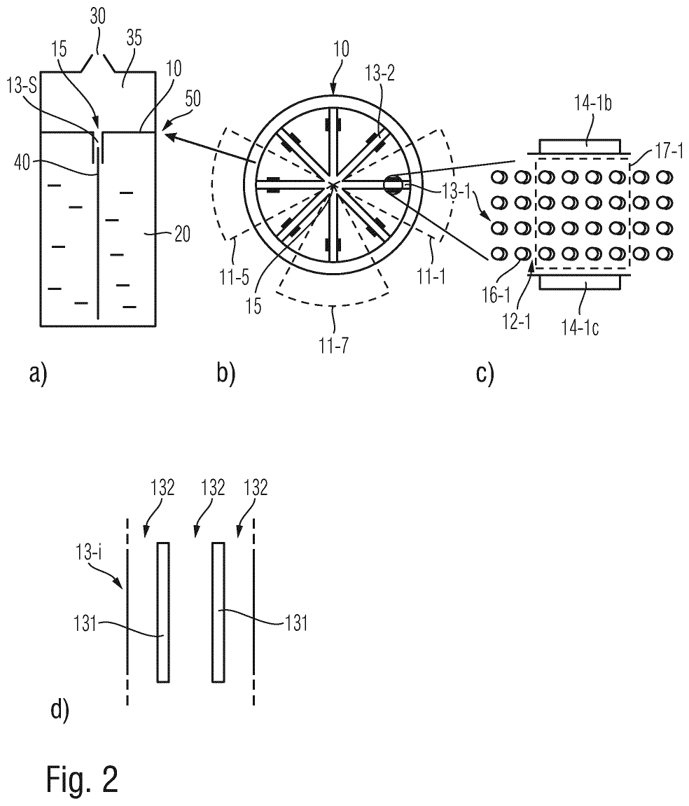

Hence, depending on the specific configuration of the electronic cigarette 1000, the liquid store 20 may be part of or configured as a separate from the vaporizer 50; 150. FIGS. 1 and 2a show an example of a liquid cartridge with an integrated liquid store 20 and vaporizer 50, a structure often referred to as a “cartomizer”.

Depending on the specific variant of the vaporizer 50, the electronic cigarette 1000 and the vaporizer 50 may be configured for use with electrically conductive liquid or for use with electrically non-conductive liquid.

As illustrated in FIG. 2a to c, the vaporizer 50 comprises an absorbing structure 10 and at least one heating element 12-1. The absorbing structure 10 is configured to receive the liquid from the liquid store 20 and transport it towards the at least one heating element 12-1.

The absorbing structure 10 can advantageously be of a planar substrate, and provided with a first side and a second side. In addition, as can be inferred from FIG. 2b, the absorbing structure 10 is circular-shaped. In the electronic cigarette 1000, the first side is positioned towards a mouthpiece 30 and the second side is positioned opposite the mouthpiece outlet.

The absorbing structure 10 can advantageously comprise a ceramic material, such as a porous ceramic material. Other possible material may comprise, or consist of, Graphene, Titanium, oxide-coated copper, or any other suitable material. The absorbing surface 10 comprises at least one channel 13-i and at least one supply conduit 13-S connected thereto. The supply conduit 13-S is thus configured to receive liquid from the liquid store 20 and transfer the liquid into the at least one channel 13-i. The at least one channel 13-i is configured such that the liquid is drawn into the at least one channel 13-i by capillary action.

As best seen in FIG. 2a, the absorbing structure 10, i.e. the first side of the substrate may be open to a vaporization cavity 35 in a direction perpendicular to the at least one channel 13-i.

Optionally, as illustrated in the embodiment of FIG. 2a, a liquid transfer element 40 (for example a wick such as a cotton wick) may be fluidically connected to the liquid store 20, for example by immerging the liquid transfer element 40 partially in the e-liquid in the liquid store 20. The liquid transfer element 40 transfers liquid from the liquid store 20, for example by capillary action, to the absorbing structure 10 of the vaporizer 50. The absorbing structure 10 interfaces with the liquid transfer element 40 (e.g. a wick) in such a way that liquid absorbed by the liquid transfer element 40 may be transferred onto the absorbing structure 10. Preferably, the liquid transfer element 40 is in direct physical contact with the absorbing structure 10. FIG. 2b) shows a top view of the absorbing surface structure 10 in FIG. 2a from the direction of the mouthpiece 30. The first side of the absorbing surface structure 10 comprises a plurality of segments 11-1, 11-2 . . . to 11-i. The segments 11-i may be formed as equally-formed segments 11-i and have a joined shape corresponding to an atomizer seating in the main body portion 1001 of the electronic cigarette 1000. Each segment 11-i may be provided with at least one corresponding dedicated heating element 12-i (only the heating element 12-1 is schematically illustrated in FIG. 2c)), i.e. the corresponding heating element 12-i is arranged and configured to heat at least part of the corresponding segment 11-i. In the origin of the radii of the segments 11-i, a supply conduit 13-S fluidically connected to an opening 15 is arranged (see FIG. 2a) through which the liquid from the liquid store 20 is received and transferred to the at least one channel 13-i. Thus, the liquid from the liquid store 20 enters the vaporizer 50 through the opening 15.

The at least one channel 13-i is arranged, in the embodiment of FIG. 2, such that one channel is arranged in each individual segments 11-i of the absorbing surface structure 10. The at least one channel 13-i is arranged perpendicularly to the supply conduit 13-S.

The absorbing surface 10 comprises a plurality of channels 13-i connected to the supply conduit 13-S. Each channel 13-i is arranged perpendicularly to the supply conduit 13-S.

The channels 13-i are arranged on the absorbing structure 10 along radial directions in a star configuration.

The channels 13-i can be provided with a microfluidic shape, where at least one channel 13-i is formed in the proximity of a heating element 12-i which enables an efficient vaporization and can therefore avoid heating when there is either insufficient or an excessive amount liquid present in the proximity of the heating element 12-i.

To this effect, the effective cross-section of the at least one channel 13-i is preferably provided with a dimension at a submillimeter scale. In an embodiment, the at least one channel has a width and/or depth of smaller than 1 micrometers, preferably between 10 nanometers and 850 nanometers.

In one particular embodiment, if there is a single channel, the effective cross-sectional area is the cross section of the individual channel. The channel can thus alone be formed as a microfluidic channel.

As schematically illustrated in FIG. 2c, the effective cross-sectional flow area is achieved by microscale structures 16-i provided within each channel 13-i such as to form microfluidic channels within each channel 13-i. Preferably these structures are on the nanoscale level. As illustrated in FIG. 2c, the microscale structures can be formed from microscale or nanoscale pegs or nanoscale columns 16-1. In another embodiment, as illustrated in FIG. 2d, the microscale structures are formed from longitudinal channel partitions 131, whereby a main channel 13-i is separated into a group of side-by-side (preferably parallel) microscale or nanoscale channels 132.

In one and the same embodiment, when there is a plurality of channels 13-i, different types of microscale structures may be formed in different channels 13-i, for example in one channel 13-i there may be pegs or columns 16-1 and in another one there may be longitudinal channel partitions 131. This may be advantageous if the electronic cigarette 1000 is usable with a variety of different types of liquids that may have different viscosity, surface tension and the like, so that different microscale structures are adapted for different types of liquids.

The at least one heating element 12-i is configured to vaporize the liquid to generate vapor. The heating elements 12-i may, for example, be realized as an Ohmic resistance heater.

The absorbing structure 10 may have a first side in which the at least one channel 13-i is arranged and a second side which comprises the at least one heating element 12-i. The substrate may comprise a single and uniform material and whereby the first side and the second side may refer to different positions or planes in the substrate.

Optionally, the absorbing structure 10 may comprise a plurality of layers, wherein the at least one channel is arranged in a first layer and the heater in a second layer.

The at least one heating element 12-i is preferably embedded in the second side or the second layer of the substrate. Thus, for example, the first layer may form walls of the channels 13-i; and the second layer, which is heatable by the at least one heating element 12-i, may form a floor of the channels 13-i. Preferably, for each channel 13-i at least one heating element 12-i is provided. There may also be a plurality of heating elements 12-i provided for each channel 13-i.

The at least one heating element 12-i may be disposed within the channels 13-i and/or embedded within a wall or a floor (or, in some variants, in a ceiling) of the respective channel 13-i so that, when the respective heating element is activated the liquid contained within the channel 13-i (or within a part of the channel 13-i) is vaporized.

Alternatively or additionally, the absorbing structure 10 may be thermally conductive such that they can dissipate heat from the at least one heating element 12-i. In such variants, the segments 11-i may comprise, or consist of, a thermally conductive material such as graphene or oxide-coated copper which is able to transmit the heat generated by the respective heating element 12-i to the respective channel 13-i.

In another preferred embodiment, the heating element 12-i is positioned on the second side of the planar substrate. The channel 13-i is provided on the first side of the planar substrate (top side) and the at least one heating element 12-i is provided on the opposite second side of the planar substrate. The at least one heating element 12-i can be shaped as a track and is aligned with the channel 13-I present in the same segment. This enables a maximum amount of heat to be transferred to the liquid in the conduit.

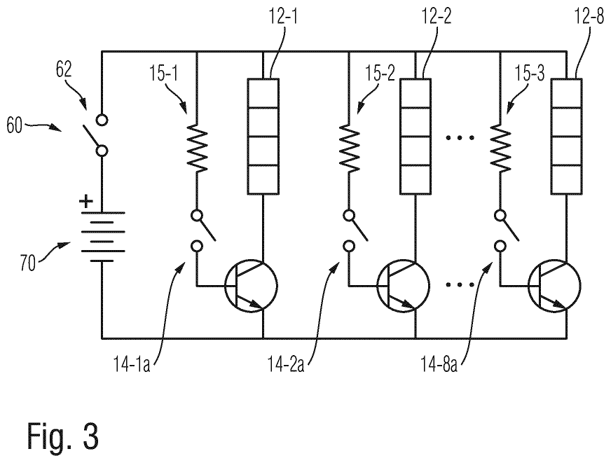

In order to control the at least one heating element 12-i to be individually active or inactive, control circuitry 60 is provided for individually controlling the heating elements 12-i. The control circuitry 60 may be arranged at least partially in the vaporizer 50; 150. Such control circuitry 60 is schematically illustrated in FIG. 3. The control circuitry 60 comprises a plurality of sensing circuits, connected to a plurality of heating elements 12-1, a main power switch 62 and electrical contacts 14-1 to 14-8.

In particular, the control circuitry 60 may be arranged and configured to selectively open and close individual electrical circuits connecting each of the heating elements 12-i to a power supply unit 70 of the electronic cigarette 1000, as will be described in the following.

As seen in FIG. 3, each individual heating element 12-i (of which only 12-1, 12-2 and 12-8 are shown for reasons of conciseness) is provided with its on switch 14-1a, 14-2a, 14-8a (or: 14-ia in general) by which the respective heating element 12-i may be switched on or off (i.e. provided with electrical power or cut off from electrical power) individually.

The control circuitry 60 may comprise, or be connected or connectable to, a user interface 64 with which a user may input control signals into the electronic cigarette 1000 and/or receive output signals from the electronic cigarette 1000. For example, the user interface 64 may in a simple case comprise only a main switch (on/off switch). It may also comprise one or more further control elements (buttons, sliders, switches), visual indicators (LEDs, displays), acoustic indicators (loudspeakers) and/or the like.

The main switch 62 (or: general on/off switch) may be provided for cutting the electric power by the power supply unit 70 off completely from all of the heating elements 12-i. Said main switch 62 may be coupled to an on/off button e.g. in a user interface 64 of the electronic cigarette 1000 and/or to a microcontroller or other controlling circuit.

In other words, in preferable variants and embodiments, as long as the main switch 62 is closed, each heating element 12-i that is currently thermally connected to a liquid to generate vapor will be active, and each heating element 12-i that is currently not thermally connected to any liquid will be inactive, wherein “thermally connected to a liquid” herein means that a sufficient amount of the heat generated by the heating element 12-i can reach a liquid to vaporize it.

Hence, one of the main ideas of the present disclosure is that only those switches 14-ia are closed only when liquid is present in the at least one channel 13-i. The control circuitry can thus be configured to only enable the supply of power to the heating element when liquid is present in the channel to which the heater is thermally connected.

Control signals for controlling the switches 14-ia may originate from a large number of diverse sources such as microcontrollers, sensors and so on which may be part of the electronic cigarette 1000 or of the vaporizer 50 in particular.

The presence of liquid in the channel is detected by separate sensing circuits 15-i. As schematically shown with respect to FIG. 2c, the electronic cigarette 1000 further comprises at least one sensing circuit 15-i. In the embodiment where the vaporizer comprises a plurality of channels 13-i and a plurality of heating elements 12-i, a plurality of sensing circuits 15-i is formed. The sensing circuit 15-i comprises a first part which is located in the vaporizer (or consumable) and a second part that is located in the main circuitry of the main body of the electronic cigarette.

The switches 14-ia (illustrated with switch 14-1a of the first segment 11-1) comprise a pair of electrodes or electrical contacts 14-1b, 14-1c which are arranged at two opposed walls of the respective channel 13-i. The volume of the respective channel 13-i between the electrical contacts 14-1b, 14-1c may thus be designated as a detecting portion 17-i of the channel 13-1. The detecting portions 17-i may span the whole channel 13-i, i.e. the whole of the respective channel 13-i may be configured as a detecting portion 17-i, e.g. by the electrical contacts 14-ib, 14-ic spanning the whole channel 13-i.

Preferably, the nanoscale structures 16-i are present at least in the detecting portion 17-i of the respective channel 13-i, more preferably at least from the opening 15 throughout at least the detecting portion 17-i, most preferably from the opening 15 throughout the complete channel 13-i until its outer radial end. Thus, the capillary effect created by the nanoscale structure 16-i acts to draw liquid from the liquid transfer element 40 at least into the detection portion 17-i.

The detecting portion 17-i is preferably arranged at least halfway along the channel 13-i starting from the opening 15, more preferably at least 60% along that way, even more preferably at least 80% along that way. The heating elements 12-i may be arranged to heat the liquid at least in a portion of a respective channel 13-i starting from the opening 15 and extending at least up to the detecting portion 17-i. In this way, the arrangement of the detecting portion 17-i (by the arrangement of the respective electrodes 14-1b, 14-1c) corresponds to a desired triggering amount (corresponding to a length along the channel 13-i) of liquid to be present in the channel 13-i before the switches 14-i shall be triggered to close and thus the heating elements 12-i be activated.

The triggering of the switches 14-i by the liquid may be performed by electric conductivity sensing or by capacitive sensing. In the case of electric conductivity sensing, the liquid used with the vaporizer 50 and electronic cigarette 1000 is a conductive liquid and the segments 11-i themselves are electrically non-conductive. Thus, an electrical connection between the electrical contacts 14-ib, 14-ic of each switch 14-ia is only created when the electrically conductive liquid is present between them and acts as a conductive bridge. Thus, the switch 14-ia acts as both a sensor and a switch at the same time.

Alternatively, the electrical connection between two electrical contacts 14-ib, 14-ic may be detected, e.g. by a microcontroller, and the switch 14-ia itself, which may be digitally controllable switch separate from the electrical contacts 14-ib, 14-ic, may be controlled by the microcontroller to close or open accordingly, i.e. to close when (and as long as) the electrical connection between the two electrical contacts 14-ib, 14-ic is detected and to open when (and as long as) the electrical connection between the two electrical contacts 14-ib, 14-ic is not detected.

In the variants with electric conductivity sensing, it is preferred if the detecting portion 17-i is only a minor portion of the entire channel 13-i, for example less than 30% of its length, less than 20% of its length, less than 10% of its length or the like. Moreover, it is preferred that said detecting portion 17-i is arranged towards the outer radial end of the channels 13-i, for example at least 50% along its length starting from the opening 15, at least 60%, at least 70%, at least 80%, at least 90% or the like. Then, due to the capillary effect created by the nanoscale structures 16-i, the closing of the switch 14-ia by the liquid (or because of the presence of the liquid in the detecting portion 17-i) indicates that the liquid is present in a corresponding percentage of the channel 13-i. The detecting portions 17-i may advantageously provide a decentralized sensing capability of the vaporizer 50.

In other variants, the vaporizer 50 and electronic cigarette 1000 may be configured for use with an electrically non-conductive liquid. The electrical contacts 14-ib, 14-ic then act as capacitor plates and the liquid in between as a dielectric. The presence/absence of liquid between the electrical contacts 14-ib, 14-ic thus affects the capacitance of the capacitor, which may be used to trigger the corresponding switch 14-ia.

For example, a microcontroller of the electronic cigarette 1000 or of the vaporizer 50 in particular may monitor the capacitance of the capacitor formed by the electrical contacts 14-ib, 14-ic and may cause the switches 14-i to open/close, respectively, when capacitance values to a specific side of a capacitance threshold value are detected. Preferably, the respective switches 14-i are closed (and stay closed) when, and as long as, a capacitance value larger than a threshold value is detected and opened (and stay open) when, and as long as, a capacitance value smaller than a threshold value is detected, with the case for a capacitance value being equal to the threshold value being put to either side.

Other forms of capacity sensing of the presence/absence of liquid within the channels 13-i are possible, as will be described later.

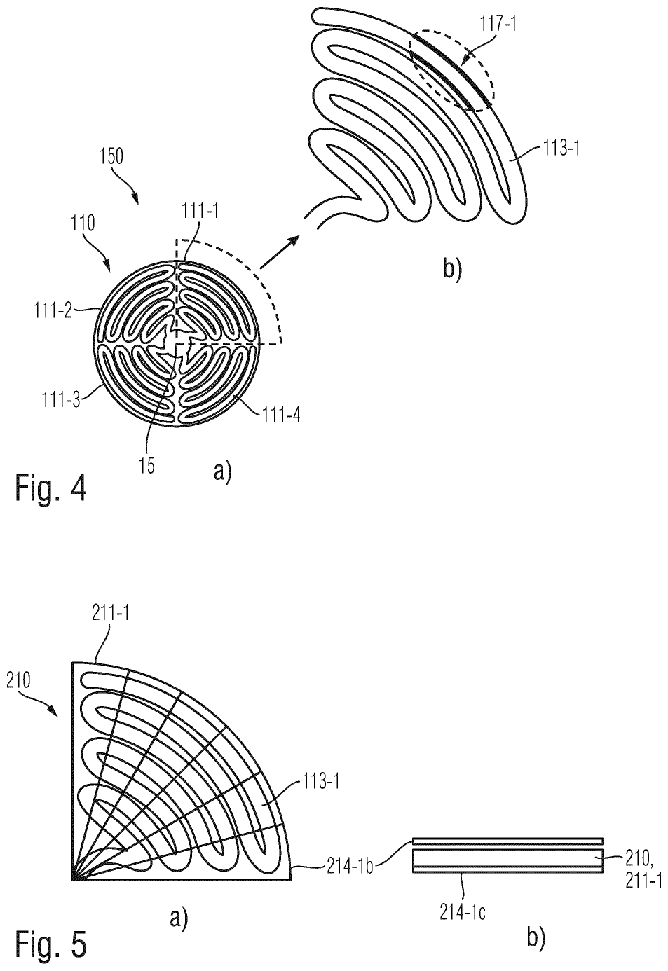

FIG. 4 schematically show details of an absorbing surface structure 110 according to vaporizer 150 according to another embodiment of the present invention. It should be understood that the vaporizer 150 may be used in an electronic cigarette 1000 that may otherwise be the same as described with respect to FIG. 1, FIG. 2 and/or FIG. 3.

FIG. 4a schematically illustrates a top view of the absorbing surface structure from the direction of the mouthpiece 30 of an electronic cigarette 1000, in analogy to the illustration in FIG. 2 b).

In the absorbing surface structure 110 in the embodiment of FIG. 3, four segments 111-1, 111-2, 111-3, 111-4 (hereafter also sometimes collectively designated as 111-i) are provided, each with at least one heating element, and each with a single channel 113-i. The segments 111-i are equally-sized and in the shape of a quarter of disk (circle sector with 90° angle). In the embodiment of FIG. 3, each channel 113-i is formed with a winding structure: the liquid changes direction multiple times along each respective channel 113-i and multiple sections of each channel 113-i are arranged essentially (or completely) in parallel to one another (and essentially perpendicular to the radial direction), and preferably the majority of the channel 113-i is comprised of sections that are arranged essentially (or completely) in parallel to one another.

Advantageously, the channel 113-i is tightly packed in each respective segment 111-i, for example such that at least 50% of the absorbing surface structure 110 covered by the channels 113-i, preferably more than 60%, more preferably more than 70%, even more preferably more than 80%. In this way, a maximum amount of liquid can be held within each channel 113-i, and when each segment 111-i is heated, e.g. by a respective heating element having essentially (or exactly) the same form as the segment 111-i, a maximum amount of liquid is heated simultaneously.

FIG. 4b) shows the structure of the channel 113-1 of the absorbing surface structure 110 in more detail. The detecting portion 117-1 of the channel 113-1 may be configured in any of the ways as has been described in the foregoing for the detecting portions 17-i of the channels 13-i, in particular in any of the variants for use with electrically conductive liquid (electrical conductivity sensing) or with non-conducting liquid (capacitive sensing).

Again, it is preferred each detecting portion 117-i is arranged towards the outer radial end of the respective channel 113-i, for example at least 50% along its length starting from the opening 15, at least 60%, at least 70%, at least 80%, at least 90% or the like. Then, due to the capillary effect created by the nanoscale structures 16-i, the closing of the switch 14-ia by the liquid (or because of the presence of the liquid in the detecting portion 117-i) means that the liquid is present in a corresponding percentage of the channel 113-i.

Additionally or alternatively, the absorbing surface structure 110 may be configured such that the detecting portions 117-i of the absorbing surface structure 110 are arranged in the respectively outermost branch of each channel 113-i, or, in other words, in a portion of the channel 113-i closest to the outer radial end of the absorbing surface structure 110. It should be understood that the detecting portions 117-i may also extend over multiple branches of the respective channel 113-i or may even extend over the whole length of the channel 113-i. In any case, it is preferred (although not necessary) that the segments 111-i of the absorbing surface structure 110 are arranged with rotational symmetry, in the present case with a rotational symmetry of C4 about a rotational axis located in the center of the absorbing surface structure 110, within the opening, and perpendicular to the disk of the absorbing surface structure 110. Of course, any other number n of segments 111-i may be provided, and thus a corresponding Cn symmetry may apply.

FIG. 5 schematically illustrates a detail of a vaporizer according to yet another embodiment of the present invention. FIG. 5 a) shows the same view as FIG. 4b), i.e. a detail of one segment 211-1 out of a plurality of segments 211-i of an absorbing surface structure 210, wherein the segments 211-i are equally-sized and equally-structured and arranged with rotational symmetry. In FIG. 5a), again n=4 segments with a C4 symmetry have been chosen as an example, with only one segment 211-1 being shown.

In the embodiment of FIG. 5, the absorbing surface structure 210 of the vaporizer is formed with the same heating elements and the same channels 113-i of winding structure as shown in, and discussed with respect to, FIG. 4. The difference in the embodiment of FIG. 5 is that there is no detecting portion 117-i arranged within the channel 113-i, but that the respective detecting portion comprises the respective entire segment 211-i. This is achieved by providing mesh-like and/or fan-like electrical contacts 214-1b, 214-1c which sandwich between them the layer of the absorbing surface structure 210 comprising the channel 113-1.

The fence-like and/or fan-like and/or mesh-like electrical contacts 214-1b, 214-1c allow generated vapor to escape through the gaps between the bars, grids or braces of the fence-like and/or fan-like and/or mesh-like electrical contacts 214-1b, 214-c while also obtaining sufficient information about the presence of liquid throughout the segment 211-i by capacitive sensing.

In this context, “fan-like” may mean that bars are arranged as connected at a central point (e.g. the radial origin of a segment 211-1 as shown in FIG. 5) and extend radially outward from there.

“Fence-like” may indicate the presence of bars alternating with gaps, wherein the bars may be parallel to one another or arranged at an angle of less than 180° to one another, preferably of less than 90°, e.g. as shown in FIG. 5a). The distances and/or gaps between each two neighboring bars are preferably identical.

“Mesh-like” may indicate at least some braces crossing other braces such as to form T-shaped junctions (e.g., as shown in FIG. 5a) at the outer radial end of the segment 211-1) or cross-shaped junctions, for example a plurality of braces forming a chess pattern.

The use of the electronic cigarette 1000 according to any of the herein described embodiments or variants, comprising any of the herein described embodiments of variants of the vaporizer 50; 150, may proceed as follow:

The liquid transfer element 40 is brought into contact with liquid stored in the liquid store 20. This may be performed during manufacture of the electronic cigarette 1000, or during assembly of the electronic cigarette 1000 by the user, for example when replacing a vaporizer 50; 150 and/or when replacing a liquid store 20. For example, the liquid store 20 may be comprised in a removable and disposable capsule, or the vaporizer 50; 150 may be a removable and disposable unit, whereas the liquid store 20 may be a refillable tank in the housing 80 of the electronic cigarette 1000.

A user may turn on the electronic cigarette 1000, e.g. by manipulating a button of the user interface 64 that operates the main switch 62. In variants with a passive liquid transfer element 40 (such as a wick), the liquid transfer element 40 may already be saturated with liquid at the point. Alternatively, turning on the electronic cigarette 1000 may also activate an active liquid transfer element 40 (such as a micropump) to start transferring liquid from the liquid store 20 to the vaporizer 50; 150.

By capillary action (due to the specific structure of the channels 13-i; 113-i of the absorbing surface structure 10; 110; 210), the liquid is then distributed by the channels 13-i; 113-i throughout the segments 11-i; 111-i. It may happen that the liquid is at times distributed unevenly between the segments 11-i; 111-i such that some segments 11-i; 111-i receive more liquid than others. The liquid enters the detecting portions 17-i; 117-i in the channels 13-i; 113-i and triggers, if the amount of liquid in a particular detecting portion 17-i; 117-i is sufficient, a corresponding switch 14-ia so as to control (or: actuate, or: activate) a corresponding heating element 12-i to start heating the corresponding segment 11-i; 111-i to generate vapor from the liquid by vaporizing it.

The amount being “sufficient” is determined by the design of the detecting portions 17-i; 117-i and/or by the design of the control circuitry 60, for example by triggering threshold values for electrical conductivity and/or capacitance, by digital thresholds programmed into a microcontroller and/or the like. The sufficient amount may, for instance, be determined based on the amount per time that can be vaporized by the heating elements 12-i continuously.

If during this process at any point the amount of liquid in any of the detecting portions 17-i; 117-i becomes too small, the corresponding switch 14-ia are opened and heating by the corresponding heating element 12-i ceases, just as in any of the detecting portions 17-i; 117-i in which the amount of liquid becomes sufficiently large, heating is (re-)started.

In the case that at any time in none of the detecting portions 17-i; 117-i a sufficient amount of the liquid is present, a signal may be provided to a user of the electronic cigarette 1000, for example via the user interface 64. For example, a sound, a melody, or a spoken message may be played to the user, or an indicator LED may be active, or a text message may be displayed by a display of the user interface 64.

Thus, the electronic cigarette 1000 has improved liquid flow and increased device component lifespan because of the targeted and precise activation/deactivation of heating elements 12-i. In particular, wick and battery lifespan are extended. Moreover, user satisfaction is improved as the overall generation of vapor is more consistent and the occurrence of “dry hits” is eliminated or at least reduced without the need for an increased device size.

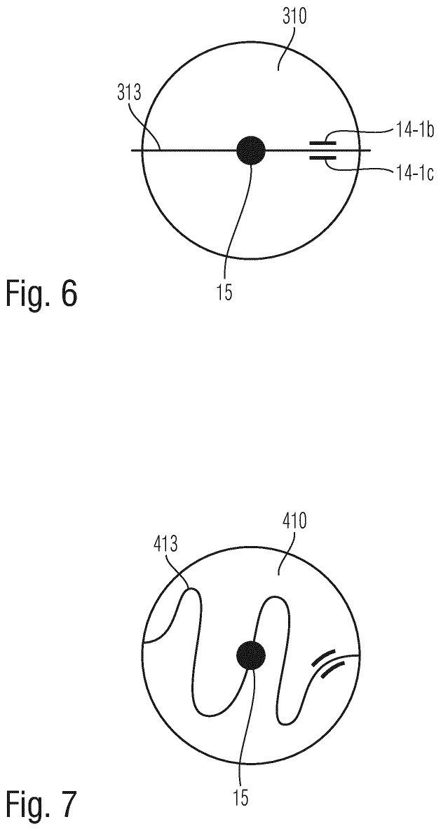

FIG. 6 schematically illustrates a detail of a vaporizer according to yet another embodiment of the present invention. FIG. 6 shows the same view as FIG. 2b), i.e. a top view of an absorbing structure 310 of a vaporizer. The absorbing structure 310 comprises a single segment 311 with a single (preferably microfluidic) channel 313. Along the sides of the channel 313, electrical contacts 14-1b and 14-1c are disposed as has been described in the foregoing. In this variant, the channel 313 is formed as a straight line or track running through the center of the absorbing structure 310, where the opening 15 is arranged, and beginning and ending at the radial outer ends of the absorbing structure 310.

The electrical contacts 14-1b and 14-1c correspond to a detecting portion 17-1 and are preferably arranged at one of the radial outer ends of the channel 313. As has been described in the foregoing, only when the presence of liquid is detected in the detecting portion 17-1, is electrical power supplied to at least one heating element. In this variant, heating elements may be arranged at/in both branches of the channel 313 extending to both sides from the opening 15.

Optionally, two pairs of electrical contacts 14-1b and 14-1c may be arranged, one at each opposite end of the channel 313, and each may be configured to detect the presence of liquid in a corresponding detecting portion for activating or deactivating a corresponding one of the two heating elements.

FIG. 7 schematically illustrates a detail of a vaporizer according to yet another embodiment of the present invention. FIG. 7 shows the same view as FIG. 6, i.e. a top view of an absorbing structure 410 of a vaporizer. The absorbing structure 410 comprises is different from the absorbing structure 310 of FIG. 6 in that a single channel 413 in the absorbing structure 410 is formed not as a straight line but as a winding or multiply-turning curve. As has been described in the foregoing with respect to FIG. 6, at least one pair of electrical contacts or two pairs of electrical contacts, at least one heating element or two heating elements and so on may be provided.

Compared to the channel 313 in FIG. 6, the channel 413 of FIG. 7 is larger even when the absorbing structure 410 of FIG. 7 has the same size as the absorbing structure 310 of FIG. 6. Thus, more liquid can be present within the absorbing structure 410 at the same time, and the amount of liquid that can be vaporized per time unit is increased.

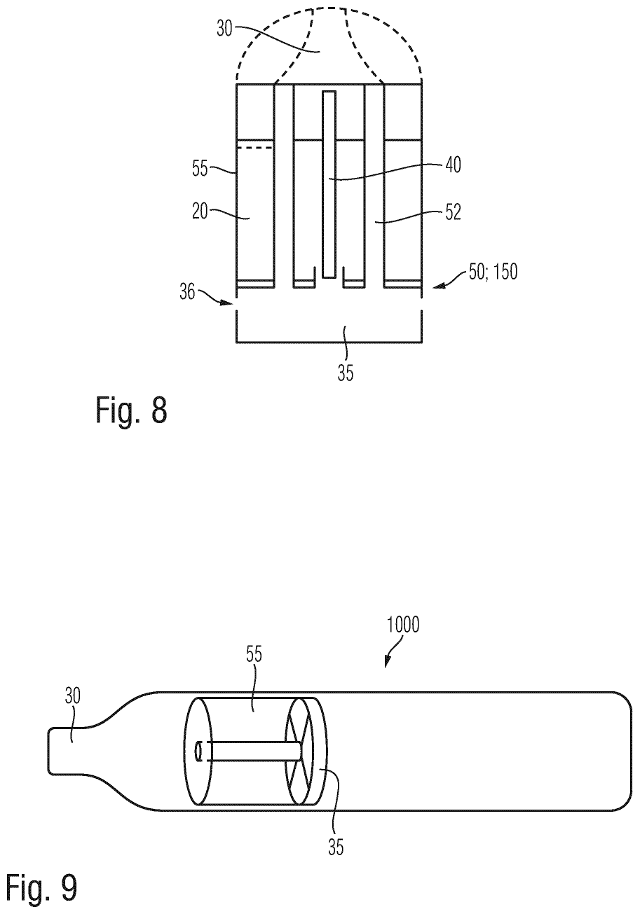

FIG. 8 schematically illustrates a cartridge 55 according to yet another embodiment of the present invention. The cartridge 55 comprises a vaporizer 50; 150 configured in any of the ways as described in the foregoing. The cartridge 55 also comprises a liquid store 20 for storing a liquid to be vaporized by the vaporizer 50. The liquid from the liquid store 20 is transported, by a liquid transport element 40, to at least one channel in the absorbing surface of the vaporizer 50; 150. The liquid transport element 40 may be an active or a passive element. One example for a passive element is an element which uses capillary force to transport the liquid, e.g. a wick.

The vaporized liquid escapes from the one or more channels into a cavity 35 into which outside air can enter via an air inlet 36. The cavity 35 is connected or connectable to a mouthpiece 30 (not necessarily part of the cartridge 55) via at least one vapor flow tube 52. The at least one vapor flow tube 52 preferable traverses—in a fluidically isolated manner—the liquid store 20 so that a very compact design is achieved.

FIG. 9 schematically illustrates an electronic cigarette 1000 in combination with the cartridge 55 of FIG. 8 inserted therein. It is shown how the cavity 35 is, compared to the mouthpiece 30, at the distal end of the cartridge 55. Apart from the vaporizer being part of the cartridge 55, the electronic cigarette may have the same features as has been described in the foregoing, in particular with respect to FIG. 1.

The cartridge 55 comprises electrical contacts for connecting to the circuitry within the electronic cigarette 1000, in particular to the power supply unit 70. Electrical terminals arranged at the cartridge 55 are configured to be connected to corresponding electrical terminals at a cartridge seating of the electronic cigarette 1000.

The cartridge seating may comprise a first pair of electrical terminals configured to power at least one heating element of the cartridge 55 and a second pair of electrical terminals configured to establish at least one control circuit.

The control circuitry 60 of the electronic cigarette 1000 comprises the controller configured to detect an electrical parameter (such as capacitance or resistance) of the at least one control circuit and control the supply of power to the at least one heating element such that power is supplied to the at least one heating element only when the detected electrical parameter is within a predefined parameter range. For example, detecting an electrical parameter may comprise measuring a value of the electrical parameter or otherwise determining whether the electrical parameter is in a predefined range. In some variants, if an electrical current flows through the at least one control circuit, this can be considered a detecting that the resistance of the at least one control circuit is in a predefined value range, i.e. a range that allows the conduction of electrical current.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise.

Moreover, the terms “first”, “second”, “third”, etc. are used merely as labels, and are not intended to impose numerical requirements on or to establish a certain ranking of importance of their objects.

Other embodiments are described with reference to the below items.

Item 1. A cartridge (55) for an electronic cigarette (1000), the cartridge (55) comprising a liquid store (20) and a vaporizer (50), the vaporizer (50) comprising at least one heating element (12-i) and an absorbing structure (10; 110; 210; 310; 410) having at least one channel (13-i; 113-i; 313; 413) fluidically connected to the liquid store (20) by a supply conduit (13-S), at least one channel (13-i; 113-i, 313; 413) being open in a direction perpendicular to a capillary flow direction within the at least one channel (13-i; 113-i; 313; 413), and wherein the at least one channel (13-i; 113-i; 313; 413) is configured to conduct liquid from the liquid store (20) to the at least one heating element (12-i).

Item 2. The cartridge (55) according to Item 1, wherein the absorbing structure (10; 210) is divided into segments (11-i; 111-i; 211-1), and wherein each segment (11-i; 111-i; 211-1) comprises a separate channel (13-i; 113-i) and each segment (11-i; 111-i; 211-1) is thermally coupled to a separate heating element (12-i).

Item 3. The cartridge (55) according to Item 1 or Item 2, wherein the vaporizer (50) is formed on a substrate, and wherein the at least one channel (13-i; 113-i; 313; 413) is formed on a first side thereof.

Item 4. The cartridge (55) according to the preceding Item, wherein the at least one heating element (12-i) is formed on the second surface thereof.

Item 5. The cartridge (55) according to Item 3 or Item 4, wherein the substrate comprises a porous ceramic material.

Item 6. The cartridge (55) according to any of Items 3 to 5, wherein the at least one heating element (12-i) is arranged on the same side as the at least one channel (13-i; 113-i; 313; 413), and preferably arranged at a bottom portion of the channel (13-i; 113-i; 313; 413).

Item 7. The cartridge (55) according to any one of the preceding Items, wherein the vaporizer (50) has a planar shape.

Item 8. The cartridge (55) according to any of Items 1 to 7, wherein the at least one heating element (12-i) is shaped as a track and is aligned with the at least one channel (13-i; 113-i; 313; 413).

Item 9. The cartridge (55) according to any one of the preceding Items, wherein the bottom of the at least one channel (13-i; 113-i; 313; 413) is coated, preferably by an impervious coating such as a vitreous glazing.

Item 10. The cartridge (55) according to any of Items 1 to 8, wherein the supply conduit (13-S) is configured to draw and transfer liquid by capillary action into at the least one channel (13-i; 113-i; 313; 413).

Item 11. The cartridge (55) according to any one of the preceding Items, wherein the vaporizer (50) further comprises a pair of electrical contacts (14-1b, 14-1c; 214-1b, 214-1c) arranged about the sides of said at least one channel (13-i; 113-i; 313; 413),

wherein the electrical contacts (14-1b, 14-1c; 214-1b, 214-1c) form part of an electrical control circuit when the cartridge (55) is arranged in an electronic cigarette (1000), and

wherein the electrical contacts (14-1b, 14-1c; 214-1b, 214-1c) are configured to establish a closed circuit and enable a power supply to the at least one heating element (12-i) only when liquid is present in the at least one channel (13-i; 113-i; 313; 413).

Item 12. The cartridge (55) according to the preceding Item, further comprising a first electrical power circuit connected to the electrical contacts (14-1b, 14-1c; 214-1b, 214-1c) and a second electrical power circuit connected to the at least one heating element (12-i).

Item 13. The cartridge (55) according to the preceding Item, wherein at least one electrical terminal of the first electrical power circuit is arranged on an outer circumference of the cartridge (55).

Item 14. The cartridge (55) according to the preceding Item, wherein the electrical contacts (14-1b, 14-1c; 214-1b, 214-1c) and the second electrical power circuit to the at least one heating element (12-i) have a common negative terminal.

Item 15. An electronic cigarette (1000) comprising a cartridge seating, a power supply unit (70) and a control circuitry (60), wherein the cartridge seating comprises a first pair of electrical terminals configured to power at least one heating element and a second pair of electrical terminals configured to establish at least one control circuit,
wherein the control circuitry (60) comprises a controller configured to detect an electrical parameter of the at least one control circuit and control the supply of power to the at least one heating element (12-i) such that power is supplied to the at least one heating element (12-i) only when the detected electrical parameter is within a predefined parameter range.

Item 16. A method of manufacturing the vaporizer (50; 150) for the cartridge (55) according to any one of the preceding Items 1 to 15, comprising the steps of:
providing a planar substrate with recesses formed as channels,
positioning the electrical contacts at a predetermined position in relation to the channels,
depositing at least one resistive heating element onto the planar substrate.

Item 17. The method according to Item 16, wherein the heater is deposited in the recesses, preferably by printing.

### LIST OF DRAWING SIGNS

10 absorbing structure
11-i segments
12 heating element
13-S supply conduit
13-i channel
14-ia switch
14-ib electrical contacts
14-ic electrical contacts
15 opening or liquid conduit
15-i sensing circuit
16-i microscale structures
17-i detecting portions
20 liquid store
30 mouthpiece
35 cavity
36 air inlet
40 liquid transfer element
50 vaporizer
52 vapor flow tube
55 cartridge
60 control circuitry
62 main switch
64 user interface
70 power supply unit
80 housing
90 vapor
110 absorbing structure
111-1 segment
113-i channel
117-1 detecting portion
150 vaporizer
210 absorbing structure
211-1 segment
214-1b electrical contact
214-1c electrical contact
310 absorbing structure
313 channel
410 absorbing structure
413 channel
1000 electronic cigarette
1001 body portion
1002 mouthpiece portion

1. A cartridge for an electronic cigarette, comprising:
a liquid store; and
a vaporizer,
the vaporizer including at least one heating element and an absorbing structure, the absorbing structure having at least one channel fluidically connected to the liquid store by a supply conduit, the at least one channel being open in a direction perpendicular to a capillary flow direction within the at least one channel,
wherein the at least one channel is configured to conduct a liquid from the liquid store to the at least one heating element;
wherein the absorbing structure is divided into a plurality of segments, and wherein each segment of the plurality of segments comprises a respective channel of the at least one channel and each segment is thermally coupled to a respective heating element; and
wherein the plurality of segments are equally-dimensioned and are joined at a location where the supply conduit is fluidically connected to an opening through which the liquid from the liquid store is received and transferred to each channel of the at least one channel, the plurality of segments radiating outwardly from the location.

2. The cartridge according to claim 1, wherein the absorbing structure is thermally conductive.

3. The cartridge according to claim 1, further comprising a control circuitry arranged at least partially in the vaporizer; the control circuitry being configured to individually control each heating element of the at least one heating element.

4. The cartridge according to claim 1, wherein the absorbing structure is defined on a substrate, and wherein the at least one channel is formed on a first side of the substrate.

5. The cartridge according to claim 4, wherein the at least one heating element is formed on a second side of the substrate, the second side opposing the first side.

6. The cartridge according to claim 4, wherein the substrate comprises a porous ceramic material.

7. The cartridge according to claim 4, wherein the at least one heating element is arranged on the first side of the substrate.

8. The cartridge according to claim 1, wherein the vaporizer has a planar shape.

9. The cartridge according to claim 1, wherein the at least one heating element is shaped as a track and is aligned with the at least one channel.

10. The cartridge according to claim 1, wherein a bottom of the at least one channel is coated.

11. The cartridge according to claim 1, wherein the supply conduit is configured to draw and transfer the liquid by capillary action into at the least one channel.

12. The cartridge according to claim 1, wherein the vaporizer further comprises a pair of electrical contacts, each electrical contact of the pair of electrical contacts being arranged adjacent to a respective side of said at least one channel,
wherein the electrical contacts of the pair of electrical contacts form part of an electrical control circuit when the cartridge is arranged in the electronic cigarette, and
wherein the electrical contacts are configured to establish a closed circuit and enable a supply of power to the at least one heating element only when the liquid is present in the at least one channel.

13. The cartridge according to claim 12, further comprising a first electrical power circuit connected to the electrical contacts and a second electrical power circuit connected to the at least one heating element.

14. The cartridge according to claim 13, wherein at least one electrical terminal of the first electrical power circuit is arranged on an outer circumference of the cartridge.

15. The cartridge according to claim 14, wherein the electrical contacts and the second electrical power circuit have a common negative terminal.

16. An electronic cigarette comprising:
a cartridge seating,
a power supply unit, and
a control circuitry,
wherein the cartridge seating comprises a first pair of electrical terminals configured to power at least one heating element and a second pair of electrical terminals configured to establish at least one control circuit,
wherein the control circuitry includes a controller configured to detect an electrical parameter of the at least one control circuit and to control a supply of power to the at least one heating element such that the power is supplied to the at least one heating element only when the detected electrical parameter is within a predefined parameter range.

17. A method of manufacturing a vaporizer for a cartridge for an electronic cigarette, comprising the steps of:
providing a planar substrate having recesses defining channels,
positioning a pair of electrical contacts at respective predetermined positions in relation to the channels,
depositing at least one resistive heating element onto the planar substrate.

18. The method according to claim 17, wherein the heater is deposited in the recesses.

19. The cartridge according to claim 7, wherein the at least one heating element is arranged at a bottom portion of the at least one channel.

20. The cartridge according to claim 10, wherein the bottom of the at least one channel is coated by an impervious coating.
